(19) United States
(12) Patent Application Publication
(10) Pub. No.: US 2025/0174373 A1
(43) Pub. Date: May 29, 2025

(54) ELECTRIC WIRE CONDUCTOR, INSULATED ELECTRIC WIRE, AND WIRING HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Eri TANAKA, Yokkaichi-shi (JP); Fumitoshi IMASATO, Yokkaichi-shi (JP); Yasuyuki OTSUKA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/841,993

(22) PCT Filed: Mar. 7, 2023
(86) PCT No.: PCT/JP2023/008492

§ 371 Date: Aug. 27, 2024

(30) Foreign Application Priority Data
Mar. 15, 2022 (JP) 2022-040578

(51) Int. Cl. H01B 7/08

(52) U.S. Cl. CPC H01B 7/08

(57) ABSTRACT

Disclosed is to provide an electric wire conductor that includes a strand of elemental wires twisted together, the strand formed into a flat shape, which can ensure high flexibility, and also to provide an insulated electric wire and a wiring harness including such an electric wire conductor.

An electric wire conductor 1 includes a strand comprising a plurality of sub-strands 2, the plurality of the sub-strands 2 including a plurality of elemental wires 3 twisted together, wherein, the strand comprises a flat portion having a flat outer shape in which a dimension in a width direction w is larger than a dimension in a height direction h, in a cross-section perpendicular to an axial direction of the strand, the plurality of the sub-strands 2 include outer sub-strands 2o and at least one of inner sub-strands 2i, the outer sub-strands 2o placed at an outer periphery of the flat portion, and the inner sub-strands 2i placed inside the outer sub-strands, a ratio of a number of outer elemental wires to a number of inner elemental wires is 2.0 or higher, where a total number of the elemental wires 3 composing the outer sub-strands 2o is defined as the number of the outer elemental wires, and a total number of the elemental wires 3 composing the inner sub-strands 2i is defined as the number of the inner elemental wires.

### TECHNICAL FIELD

The present disclosure relates to an electric wire conductor, an insulated electric wire, and a wiring harness.

### BACKGROUND ART

A flat cable including a flat-shaped electric wire conductor has been known. The flat cable occupies a smaller space for routing than a conventional electric wire including an electric wire conductor having a substantially circular cross-section.

In a conventional flat cable, a flat rectangular conductor is often used as an electric wire conductor as disclosed in Patent Literatures 1 and 2. The flat rectangular conductor is made of a single metal wire formed into a rectangular cross-section. Patent Literatures 3 and 4 applied by the present applicants, disclose an electric wire conductor in which a strand obtained by twisting a plurality of elementary wires together is made into a flat shape from the view point of achieving both flexibility and space-saving property.

### CITATION LIST

### Patent Literature

PTL1: JP 2014-130739 A
PTL2: JP 2019-149242 A
PTL3: International Publication WO 2019/093309
PTL4: International Publication WO 2019/177016
PTL5: JPS63-158710 A
PTL6: JP 2009-087868 A

### SUMMARY OF INVENTION

### Technical Problem

As disclosed in Patent Literatures 3 and 4, using an electric wire conductor obtained by forming a strand into a flat shape can save space while maintaining flexibility. However, when a force is applied to the strand to form it into a flat outer shape, a load is applied to elemental wires composing the strand. When a load is applied, the elemental wires are deformed. As disclosed in Patent Literatures 3 and 4, for the elemental wires located at an outer periphery of the electric wire conductor, deformation can be kept small, while the elemental wires located at an inner side are susceptible to greater deformation than the elemental wires located at the outer periphery. If deformation of the elemental wires becomes large, the elemental wires may become crowded or adhere to each other, and a material composing the electric wire may harden, which may reduce flexibility of the electric wire conductor. Especially, when the electric wire conductor is formed into a horizontally long and highly flat shape, in order to reduce a height occupied by the electric wire conductor and enhance space-saving properties, decrease in flexibility is likely to occur due to deformation of the elemental wires located at the inner side.

It is therefore an object of the present invention to provide an electric wire conductor that includes a strand of elemental wires twisted together, the strand formed into a flat shape, which can ensure high flexibility, and also to provide an insulated electric wire and a wiring harness including such an electric wire conductor.

### Solution to Problem

An electric wire conductor of the present disclosure includes a strand including a plurality of sub-strands, the plurality of the sub-strand including a plurality of elemental wires twisted together, wherein, the strand includes a flat portion having a flat outer shape in which a dimension in a width direction is larger than a dimension in a height direction, in a cross-section perpendicular to the axial direction of the strand; the plurality of the sub-strands include outer sub-strands and at least one of inner sub-strands, the outer sub-strands placed around an outer periphery of the flat portion, and the inner sub-strands placed inside the outer sub-strands, a ratio of a number of outer elemental wires to a number of inner elemental wires is 2.0 or higher, where a total number of the elemental wires composing the outer sub-strands is defined as the number of the outer elemental wires, and a total number of the elemental wires composing the inner sub-strands is defined as the number of the inner elemental wires.

An insulated electric wire of the present disclosure includes the electric wire conductor and an insulation coat covering the outer periphery of the electric wire conductor. A wiring harness of the present disclosure includes the insulated electric wire.

### Advantageous Effects of Invention

An electric wire conductor of the present disclosure is an electric wire conductor that includes a strand of elemental wires twisted together, the strand formed into a flat shape, which can ensure high flexibility. Also, an insulated electric wire and a wiring harness of the present disclosure include such an electric wire conductor.

### BRIEF DESCRIPTION OF DRAWINGS

FIG. 1 is a sectional view schematically illustrates an electric wire conductor in a flat outer shape according to an embodiment of the disclosure. In a main figure, indication of each of elemental wires composing a sub-strand is omitted, and an enlarged view enclosed by a square illustrates an example of a cross-section of a sub-strand including an elemental wires.

FIGS. 2A and 2B are cross-sectional views illustrating raw strands for forming the electric wire conductor having a flat outer shape. FIG. 2A illustrates a raw strand as a raw material for the electric wire conductor according to an embodiment of the present disclosure, while FIG. 2B illustrates a raw strand formed as a conventional general strand in which sub-strands are included at maximum density.

FIGS. 3A to 3D are photographs showing that twisted structures of the electric wire conductors of prepared samples A2 and A5 are untwisted. FIGS. 3A and 3C show states in which the twisted structure of an outer layer is untwisted on a sub-strand basis for samples A2 and A5, respectively. FIGS. 3B and 3D show states in which the twisted structure of the inner layer is untwisted on a sub-strand basis, with the outer layer being removed.

FIGS. 4A to 4D are photographs of cross-sections of conductors of representative samples, showing samples A2, A5, B2, B5, respectively.

FIGS. 5a and 5b are graphs showing a relationship between an elemental-wire ratio and a repulsive force. FIG. 5A shows a case where a flattening ratio is 5, and FIG. 5B shows a case where a flattening ratio is 6.

### DESCRIPTION OF EMBODIMENTS

### Description of Embodiment of Disclosure

An embodiment of the disclosure will be described. An electric wire conductor according to the present disclosure includes a strand including a plurality of sub-strands, the plurality of the sub-strands including a plurality of elemental wires twisted together, wherein, the strand includes a flat portion having a flat outer shape in which a dimension in a width direction is larger than a dimension in a height direction, in a cross-section perpendicular to the axial direction of the strand; the plurality of the sub-strands include outer sub-strands and at least one of inner sub-strands, the outer sub-strands placed around an outer periphery of the flat portion, and the inner sub-strands placed inside the outer sub-strands, a ratio of a number of outer elemental wires to a number of inner elemental wires is 2.0 or higher, where a total number of the elemental wires composing the outer sub-strands is defined as the number of the outer elemental wires, and a total number of the elemental wires composing the inner sub-strands is defined as the number of the inner elemental wires.

In the flat portion of the electric wire conductor, a ratio of the number of the outer elemental wires to the number of the inner elemental wires is 2.0 or higher. In other words, the number of the elemental wires composing an inner part of the electric wire conductor is smaller than ½ the number of the elemental wires composing the outer periphery of the electric wire conductor. Because the inner-elemental-wire number is small, when the electric wire conductor is deformed into a flat shape by applying a force to form a flat portion, the elemental wires located at the inner side of the electric wire conductor are less likely to deform due to a large load. Then, in the inner part of the electric wire conductor, the elemental wires are less crowded and less adhered to each other compared to a case where the number of the elemental wires placed in an inner side of the electric wire conductor is large, and the inner elemental wires are more likely to move when the electric wire conductor is subjected to bending. In addition, deformation of the elemental wires does not easily affect hardening of the constituent materials. As a result, the electric wire conductor has high flexibility.

Here, the sub-strands preferably have an identical number of the elemental wires to each other, and the ratio of the number of the outer sub-strands to the number of the inner sub-strands is preferably 2.0 or higher. Then, by using an identical sub-strand throughout the entire electric wire conductor and setting the number of the sub-strand to be placed around the outer periphery and the inner part of the electric wire conductor, it is possible to obtain the electric wire conductor having the small number of the elemental wires composing the inner part and having high flexibility in the flat portion, as described above. In addition, the ratio of the number of the outer elemental wires to the number of the inner elemental wires is preferably 3.0 or higher. Then, flexibility of the electric wire conductor can be particularly easily increased.

The inner sub-strands are preferably provided in one layer around an inner periphery of the outer sub-strands. As a result, the flexibility of the electric wire conductor, which can be obtained by reducing the number of the inner elemental wire comprising the inner part, can be effectively improved, compared to when the inner sub-strand is placed in two or more layers.

In the cross-section of the electric wire conductor, a dimension in a width direction is preferably five times larger than a dimension in a height direction. Then, a height occupied by the electric wire conductor can be reduced and space-saving properties can be improved. The more the electric wire conductor is formed into a highly flattened shape, the greater the load applied to the elemental wires composing the inner part, and flexibility of the electric wire conductor is likely to be reduced. However, if the ratio of the number of the outer electric wires to the number of the inner electric wires is set to 2.0 or higher as described above, high flexibility can be ensured even when a highly flattened shape as described above is adopted.

An insulated electric wire according to the present disclosure includes the electric wire conductor, and an insulation coat covering the outer periphery of the electric wire conductor. Further, a wiring harness according to the present disclosure includes the insulated electric wire. The insulated electric wire and the wiring harness include the electric wire conductor which has high flexibility by reducing the number of the elemental wires placed in the inner side of the electric wire conductor. Therefore, the insulated electric wire and the wiring harness as a whole can also take advantage of the high flexibility.

### Detailed Description of Embodiment of Disclosure

Hereinafter, an electric wire conductor, an insulated electric wire and a wiring harness according to embodiments of the present disclosure will be described in detail with reference to the drawings. In the present specification, with regard to a shape of each part of the electric wire conductor, concepts indicating a shape and arrangement of components, such as straight, parallel, perpendicular include errors from the geometric concepts, such as deviations of approximately +/−15° in length and approximately +/−15° in angle, within a range permissible for this type of electric wire conductor, insulated electric wire, and wiring harness. In the present specification, unless otherwise specified, the cross section of the electric wire conductor refers to a cross section cut perpendicular to an axial direction (longitudinal direction). In addition, various properties are values evaluated at room temperature in the atmosphere.

### [Summary of Electric Wire Conductor, Insulated Electric Wire, and Wiring Harness]

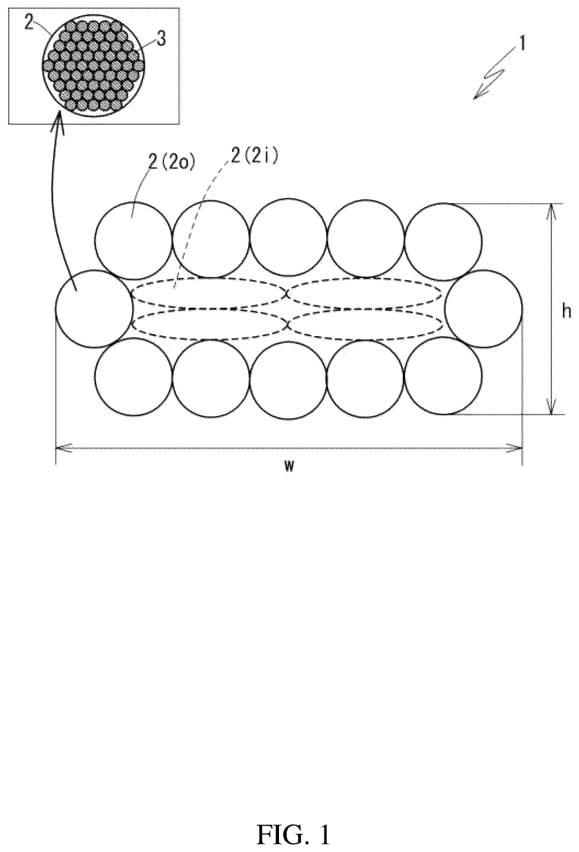

FIG. 1 illustrates schematically a cross-section of an electric wire conductor 1 according to a first embodiment of the present disclosure. The electric wire conductor 1 is formed to include a strand in which a plurality of elemental wires 3 are twisted together.

The electric wire conductor 1 has a flat outer shape at least a part along an axial direction. That is, the electric wire conductor 1 has a flat portion in which a cross-section perpendicular to the axial direction of the electric wire 1 has a flat outer shape. The present embodiment will describe a mode in which an entire axial direction of the electric wire conductor 1 is formed into such a flat portion. Here, the description that the electric wire conductor 1 has a cross-section having a flat outer shape refers to a state in which the width, w, which is a dimension of the longest straight line among the straight lines within an entire cross-section that crosses the cross-section parallel to the sides or diameter that constitute the cross-section, is greater than the height, h, which is the dimension of the straight line that is perpendicular to the longest straight line within the entire cross-section.

The cross-section of the electric wire conductor 1 may have any specific shape as long as having a flat outer shape. Examples of the flat outer shape include a rectangle, an ellipse, an oblong, an oval (a rectangle with semicircles on both ends), a parallelogram, and a trapezoid. If a circumscribing figure of the cross-section can be approximated to each of these shapes, the cross-sectional shape of the electric wire conductor 1 can be regarded as taking each of these shapes. Among the shapes listed above, any one of the shapes including the rectangle, the ellipse, the oblong, and the oval is preferred to be adopted. In the mode illustrated in FIG. 1, the electric wire conductor 1 has a cross-sectional shape that can be approximated as an oval.

In the electric wire conductor 1, all the elemental wires 3 are not twisted together as a whole, but are divided into a plurality of sub-strands 2. That is, a plurality of the elemental wires 3 are twisted together to form each sub-strand 2, and the electric wire conductor 1 is formed as a conductor wire including a plurality of the sub-strands 2. In the main figure of FIG. 1, the cross-section of each sub-strand 2 is illustrated in a simplified form as a circle or an ellipse drawn with solid lines (outer sub-strand 20) and dashed lines (inner sub-strand 2i), and an example of a structure of the sub-strand 2 including the elemental wires 3 are illustrated in a cross-sectional view enclosed in a rectangle. In the electric wire conductor 1, the sub-strands 2 may be simply assembled in a bundle, but the sub-strands 2 preferably have a superior twist structure in which a plurality of the sub-strands 2 are twisted together. Each of the sub-strands 2 may have a cross-section that is approximately a circle or a cross-section that is deformed from a circle. FIG. 1 illustrates a mode in which the sub-strands placed in the inner part of the cross-section (inner sub-strands) 2i are deformed into a flat shape.

The electric wire conductor 1 can be formed by rolling a raw strand in which a plurality of the sub-strands 2 are twisted to have an substantially circular cross-section, as described in detail later. With molding into a flat shape, at least a portion of the sub-strands 2 and each of the elemental wires 3 composing the electric wire conductor 1 may have a cross-sectional shape that is deformed from a circular shape. Deformation ratio of the sub-strand 2 and the elemental wire 3 from a circular shape is often smaller at the outer periphery of the cross-section of the electric wire conductor 1, particularly at both ends in the width direction, than at the inner part. The electric wire conductors of embodiments shown in FIGS. 4A to 4D, respectively, have a smaller deformation ratio of the elemental wires at both ends in a width direction.

In an electric wire including the electric wire conductor 1 according to the present embodiment, the electric wire conductor 1 has a flattened cross-section, which allows a space required for routing to be reduced compared to an electric wire having a substantially circular cross-section of an identical conductor cross-sectional area. In other words, it is possible to reduce a space around a certain electric wire in which other electric wires or other components cannot be placed. Especially, it is possible to reduce a space occupied by an electric wire along a height direction, allowing space savings to be achieved easily. In addition, the electric wire conductor 1 includes a strand in which the elemental wires 3 are twisted together, which allows higher flexibility than a flat conductor with a single wire having an identical conductor cross-sectional area. The electric wire conductor 1 exhibits high flexibility, particularly in a height direction. As mentioned above, the electric wire conductor 1 having a flat outer shape provides both high space savings and flexibility. An insulated electric wire and a wiring harness including the electric wire conductor 1 has both high space-saving properties and flexibility, which is particularly suitable in applications where routing is required in narrow spaces or complex paths, such as inside an automobile.

From the viewpoint of particularly enhancing space-saving properties in the height direction, a width of the cross-section of the electric wire conductor 1 is preferably three or more times as large as the height. In other words, a flattening ratio w/h is preferably 3 or higher. The flattening ratio of 5 or more is more preferable. The upper limit of the flattening ratio of the electric wire conductor 1, although no particular upper limit is set, is preferably kept at 8 or less from the viewpoint of avoiding application of an excessive load to the electric wire conductor 1 accompanied by being molded into a flat shape.

A material for composing the electric wire conductor 1 is not particularly limited and various metal materials can be applied. Representative metal materials composing the electric wire conductor 1 includes copper and copper alloy, or aluminum or aluminum alloy. Especially, aluminum and aluminum alloy have lower electrical conductivity than copper and copper alloy, and therefore, the conductor cross-sectional area tends to be large in order to secure necessary electrical conductivity. For this reason, an effect of improving space-saving properties by flattening the electric wire conductor 1 is significant. In addition, the larger the conductor cross-sectional area, the larger the effect of securing flexibility by reducing the number of the elemental wires 3 included in an inner layer, as described later. From these viewpoints, the electric wire conductor 1 is preferably composed of aluminum or aluminum alloy.

Further, from the same viewpoint, the conductor cross-sectional area is preferably 16 mm² or larger. Since the electric wire conductor 1 is formed as an assembly of the sub-strands 2 rather than a bundle of the elemental wires 3, the elemental wires 3 can be efficiently twisted together and formed into a flat shape even when the conductor cross-sectional area is large. The conductor cross-sectional area, although no upper limit is set, is preferably kept smaller than 300 mm², for example, from a viewpoint of easily ensuring bending flexibility. In addition, an outer diameter of each elemental wire 3 composing the electric wire conductor 1, although not specifically limited, may be within a range of 0.12 mm or larger and 0.5 mm or smaller, for example. The elemental wires 3 forming the electric wire conductor 1 are preferably identical to each other, that is, made of an identical material and have an identical outer diameter.

The insulated electric wire according to one embodiment of the present disclosure includes the electric wire conductor 1 and an insulation coat (not shown). The insulation coat covers the entire circumference of the electric wire conductor 1. A material for composing the insulation coat is not specifically limited as long as the material is an insulated material, but a material whose base material is an organic polymer is preferable. Examples of the organic polymer include an olefin-based polymer such as polyolefin and an olefin copolymer, a halogen-based polymer such as polyvinyl chloride, various elastomers, and rubbers. The organic polymer may be crosslinked or foamed. Further, the insulation coat may include various additives such as a flame retardant, in addition to the organic polymer. The insulation coat is preferably formed as an extrusion.

The insulated electric wire according to an embodiment of the present disclosure may be used alone or as a component of the wiring harness according to an embodiment of the present embodiment. The wiring harness according to an embodiment of the disclosure includes the insulated electric wire according to an embodiment of the present disclosure. The wiring harness may include a plurality of the insulated electric wires according to an embodiment of the e present disclosure, or may include other types of insulated electric wires in addition to the insulated electric wire according to an embodiment of the present disclosure. Preferably, the insulated electric wires according to an embodiment of the present disclosure are placed in width and/or height directions. In this case, a specific arrangement structure of the insulated electric wires are not specifically limited, but an example of a preferred embodiment includes that the insulated electric wires are placed in the width direction and fixed to a common sheet material by fusion bonding. In this case, it is particularly preferable if the insulated electric wires placed side by side have an identical height.

### <Details of Structure of Electric Wire Conductor>

The electric wire conductor 1 according to an embodiment of the present disclosure is formed to include a plurality of the sub-strands 2 including a plurality of the elemental wires 3 twisted together. In the electric wire conductor 1, the sub-strands 2 are placed in layers. Here, the description “the sub-strands 2 are placed in layers” refers to a state in which the sub-strands 2 are placed in a substantially circular shape over a plurality of layers along a direction connecting the outer periphery and a center of the electric wire conductor 1 (the same applies below to a case where a number of layers of the sub-strands 2 is defined). For the inner layer, the arrangement in the substantially circular shape also includes an arrangement of a single wire alone and an arrangement linearly in the width direction.

More specifically, in the electric wire conductor 1, the sub-strands 2 placed around the outer periphery of the flattened cross-section compose an outer layer as the outer sub-strand 20. In addition, the sub-strands 2 placed in an inner part of the outer sub-strands 2o in the cross-section compose an inner layer as the inner sub-strands 2i. All of the sub-strands 2 located at the inner side of the outer sub-strands 2o are the inner sub-strands 2i. By definition, the outer layer is formed of the outer sub-strands 2o of a single layer alone. Meanwhile, the inner layer may be formed of the inner sub-strands 2i of one layer or a plurality of layers.

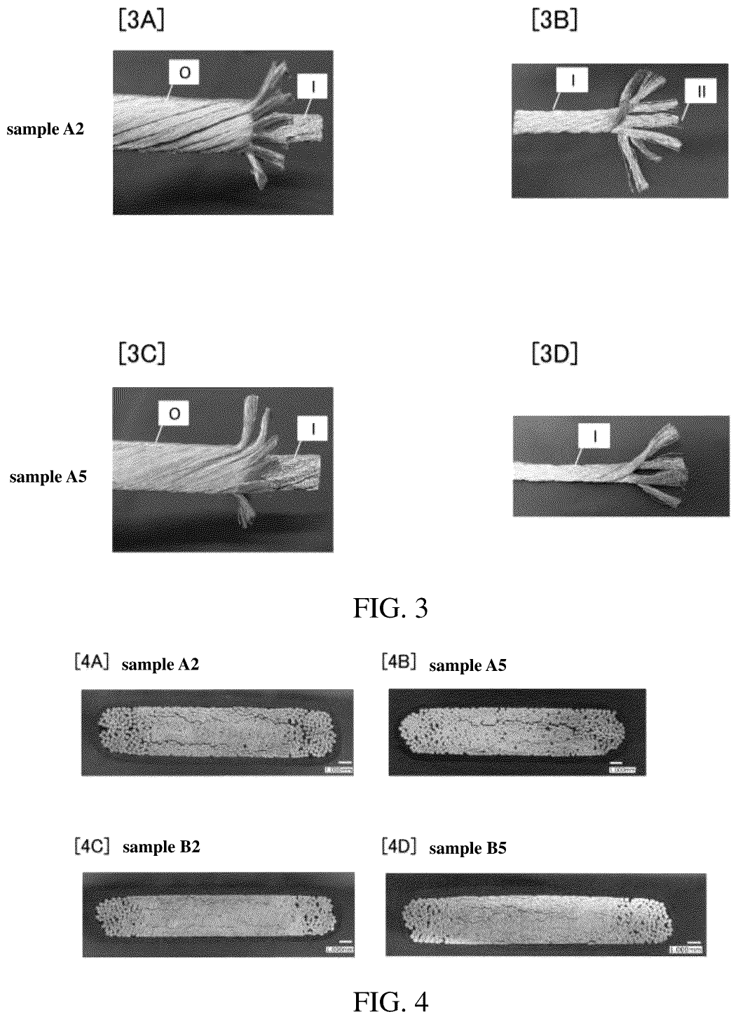

Each of the sub-strand 2 composing the electric wire conductor 1 may be clearly confirmed by visually observing the sub-strands 2 as a per-unit while untwisting the electric wire conductor 1, for example, as shown in FIGS. 3A to 3D. When the electric wire conductor 1 has a superior twisting structure, the superior twisting structure may be untwisted. As shown in FIGS. 3A to 3D, if the twisted structure of the electric wire conductor 1 is untwisted on a sub-strand 2 basis, the outer sub-strands 2o may be clearly distinguished from the inner sub-strands 2i, and also each layer of the inner sub-strands 2i may be clearly distinguished from one another when the inner sub-strands 2i are composed of a plurality of layers.

In the electric wire conductor 1 according to an embodiment, a ratio of the number of the elemental wires 3 composing the outer layer to the number of the elemental wires 3 composing the inner layer is within a predetermined range. Here, a total number of the elemental wires 3 composing the outer sub-strands 2o, that is, a total number of the elemental wires 3 included in the outer layer is defined as a number of the outer elemental wires (Nₒ) while a total number of the elemental wires 3 composing the inner sub-strands 2i, that is, a total number of the elemental wires 3 included in the inner layer is defined as a number of the inner elemental wires (Nᵢ). Then, the number of the outer elemental wires “N.” to the number of the inner elemental wires “Nᵢ” (Nₒ/Nᵢ) is defined as an elemental-wire ratio. In the electric wire conductor according to the present embodiment, the elemental-wire ratio is 2.0 or higher. In other words, the number of the elemental wires 3 composing the inner layer is half or less of the number of the elemental wires 3 composing the outer layer.

In general, when a sub-strand structure is employed in an electric wire conductor, a plurality of sub-strands preferably have an identical number of elemental wires to each other. Similarly, in the electric wire conductor 1 according to the present embodiment, the sub-strands 2 preferably have an identical number of the elemental wires 3 to each other in view of a structural simplicity of the electric wire conductor 1. In this case, the ratio of the number of the inner sub-strands 2i to the number of the outer sub-strands 2o is identical to the elemental-wire ratio. In other words, in the electric wire conductor 1 according to the present embodiment, the ratio of the number of the outer sub-strands 2o to the number of the inner sub-strands 2i is 2.0 or higher. Hereinafter, unless otherwise specified, a description will be made for an embodiment in which the number of the elemental wires 3 composing each of the sub-strands 2 is identical. In an embodiment shown in FIG. 1, the number of the outer sub-strands 2o is 12; the number of the inner sub-strands 2i is 4; and the ratio thereof, that is, the elemental-wire ratio is found by 12 divided by 4, which is 3.

In the electric wire conductor 1 according to the present embodiment, the elemental-wire ratio is 2.0 or higher, and the number of the elemental wires 3 composing the inner layer is kept small. Therefore, a density of the elemental wires 3 filled in the inner portion of the electric wire conductor 1 is kept small, and gaps between the elemental wires 3 are easily secured. As a result, when the electric wire conductor 1 is subjected to bending, the elemental wires 3 are more likely to move inside the electric wire conductor 1, and the electric wire conductor 1 can obtain high flexibility.

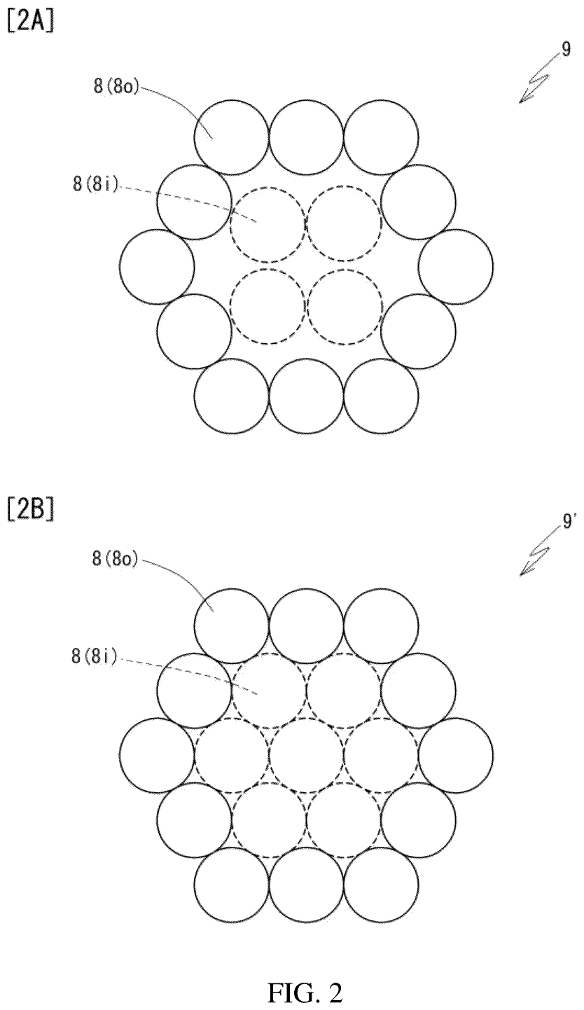

Especially, when the electric wire conductor 1 is formed into a flat shape by applying a force by rolling to a raw strand 9 in which a plurality of sub-strands 8 are twisted together have a substantially circular cross-section (or a substantially hexagonal cross-section; the same applies below) as shown in FIG. 2A, if an elemental-wire ratio is set to 2.0 or higher, an effect of improving flexibility is increased. In general, when a force that causes deformation is applied to an electric wire conductor, a large load is likely to be applied to elemental wires placed in an inner portion, where many elemental wires are placed closely to each other in a limited space, than to an outer periphery of the electric wire conductor. Then, in many cases the elemental wires in the inner portion of the electric wire conductor are deformed and crowded, and the deformed shapes of the electric wires tend to fit into each other, making it easier for the elemental wires to be in close contact with each other. As described above, when the elemental wires are crowded and in close contact with each other, the elemental wires are less likely to move relative to each other. In addition, as the elemental wires are deformed, a material composing the elemental wires is likely to harden (work-hardening). As a result of the restriction of the relative movement of the elemental wires and the hardening of the material, the electric wire conductor becomes less flexible. However, in the electric wire conductor 1 according to the present embodiment, the elemental-wire ratio of the number in the inner elemental wires is kept at 2.0 or lower, which allows keeping less force to be applied to each of the elemental wires 3 in the inner layer, even if a force is applied by rolling when flattened. Further, the degree of crowding and adhesion of the elemental wires 3 and a degree of hardening of a component material is reduced. As a result, the flexibility of the electric wire conductor 1 is maintained, allowing flexible bending or deforming the electric wire conductor 1.

As described above, the electric wire conductor 1 according to the present embodiment has the elemental-wire ratio of 2.0 or higher, and the number of the outer elemental wires is kept smaller than the number of the inner elemental wires, thereby obtaining high flexibility by both an effect of facilitating relative movement of the elemental wires 3 and an effect of suppressing hardening associated with deformation of the elemental wires 3. From a viewpoint of particularly enhancing the effect of improving flexibility, the elemental-wire ratio is preferably 2.5 or higher, and more preferably 3.0 or higher. As described above, the electric wire conductor 1 preferably has a flattening ratio w/h of the flat shape of 3 or higher, and more preferably 5 or higher. Meanwhile, if the elemental-wire ratio is 2.0 or higher, the electric wire conductor 1 can secure high flexibility even when the electric wire conductor 1 is formed into such a highly flattened outer shape. Although an upper-limit of the elemental-wire ratio is not specifically set, the elemental-wire ratio may be 3.5 or lower, for example. If the improvement of flexibility of the electric wire conductor 1 is prioritized, a mode setting the elemental-wire ratio to 3.0 or higher is also preferable, but if priority is given to stably maintaining a flat outer shape in addition to a certain degree of flexibility, the elemental-wire ratio is preferably kept at around 3.0 or lower.

As described above, if the electric wire conductor 1 having a flat outer shape is formed by deforming the raw strand 9, the arrangement of the sub-strands 8 in the raw strand 9 is carried over to the electric wire conductor 1 subjected to flattening. In other words, in the raw strand 9 illustrated in FIG. 2A, raw outer sub-strands 8o placed around an outer periphery and raw inner sub-strands 8i placed in the inner portion of the raw outer sub-strands 8o become the outer sub-strands 2o and the inner sub-strands 2i, respectively, in the flattened electric wire conductor 1. Therefore, the numbers of the raw outer sub-strands 8o and the raw inner sub-strands 8i in the raw strand 9 may be set by the elemental-wire ratio desired in the flattened electric wire conductor 1. A ratio of the number of the raw outer sub-strands 8o and the number of the raw inner sub-strands 8i directly corresponds to a ratio of the number of the outer sub-strands 2o to the number of the inner sub-strands 2i, in the flattened electric wire conductor 1. Further, in the raw strand 9, if the sub-strands 8 have an identical number of the elemental wires to each other, the ratio directly corresponds to the elemental-wire ratio in the electric wire conductor 1.

The raw strand 9 illustrated in FIG. 2A includes 4 raw inner sub-strands 8i, and 12 raw outer sub-strands 80. As illustrated in FIG. 1, the raw strand 9 is subjected to flattening, thereby obtaining the electric wire conductor 1 which includes 4 inner sub-strands 2i, and 12 outer sub-strands 2o, and has the elemental-wire ratio of 3. Meanwhile, FIG. 2B illustrates a raw strand 9′ composed of a conventional electric wire conductor having a substantially circular cross-section, in which the sub-strands 8 are placed at maximum density in concentric layers. Here, the raw inner sub-strands 8i includes a single sub-strand 8 located at a center and 6 sub-strands 8 placed around the center in one circle at maximum density, totaling 7 sub-strands 8. As the raw outer sub-strands 8ₒ, 12 sub-strands 8 are further included around the outer periphery in one circle at maximum density. If the raw strand 9′ is deformed into a flat shape, the number of the outer sub-strands 2o becomes 12; the number of inner sub-strands 2i becomes 7; and the elemental-wire ratio becomes 12/7, which is 1.71. This elemental-wire ratio is lower than 2.0. As described the following examples, flexibility is likely to be lower in the electric wire conductor having an elemental-wire ratio of lower than 2.0. In other words, if the conventional electric wire conductor in which the sub-strands 8 are placed at maximum density are used as the raw strands 9′ and subjected to flattening, high flexibility is hardly obtained.

As described above, the inner layer may be composed of the inner sub-strand 2i in one layer alone or in a plurality of layers. Here, assuming that two layers of the inner sub-strands 2i are placed and one layer of the outer sub-strands 2o are placed around the inner sub-strands 2i, a layer structure of the sub-strands 2 in the electric wire conductor is represented as “a-b-c.” Here, a is a number of the sub-strand 2 composing an inner layer among the two layers of the inner layer; bis a number of the sub-strands 2 composing an outer layer among the two layers of the inner layer, and c is a number of the sub-strand 2 composing the outer layer (b+0, c #0). When the inner layer formed by only one layer, a=0, while the number of the sub-strands 2 composing that one layer of the inner layer is b. When the layer structure is indicated in this manner, the number of the inner sub-strands 2i is found by “a+b” while the ratio of the number of the outer sub-strands 2o to the number of the inner sub-strands 2i, that is, the elemental-wire ratio is found by c/(a+b). A layer structure of the electric wire conductor 1 illustrated in FIG. 1 formed from the raw strand 9 illustrated in FIG. 2A is represented as “0-4-12.” Meanwhile, a layer structure of the electric wire conductor formed from the raw strand 9′ illustrated in FIG. 2B is represented as “Jan. 6, 2012.”

In the present embodiment, as shown in FIG. 1 and FIG. 2A, the flattened electric wire conductor 1 and the raw strand 9, respectively, are preferably provided with only one layer (one circle) of the inner sub-strands 2i on the inner periphery of the outer sub-strands 2o, that is, a layer structure “0-b-c.” As a result, the number of the inner sub-strands 2i can be reduced, thereby easily achieving a lower value of the elemental-wire ratio, and the flexibility of the electric wire conductor 1 can be effectively increased. For the same reason, even if the inner layer is formed of a plurality of layers of the inner sub-strands 2i, the number of layers is preferably kept two. As the inner layer of a two-layer structure, a layer composed of the plurality of the inner sub-strands 2i may be preferably placed around one inner sub-strand 2i, that is, a layer structure of “1-b-c” is preferable. The values of b and c are not particularly specified and may be set appropriately taking into consideration of a required conductor cross-sectional area, but a value range of 4 or higher and 6 or lower can be suitably employed as b. In this case, a value range of 8 or higher or 12 or lower can be suitably employed as c. Particularly preferred layer structures include “0-4-8,” “0-6-12,” and “0-4-12.” Especially, the layer structure “0-4-12” is preferable.

As described above, the electric wire conductor 1 according to the present embodiment has a small number of the elemental wires 3 composing the inner layer so that the elemental-wire ratio is 2.0 or higher, thereby obtaining high flexibility. The flexibility of the electric wire conductor 1 can be evaluated, for example, by a repulsive force when the electric wire conductor 1 is bent. The smaller repulsive force generated when the electric wire conductor 1 is bent at a given bending radius, the higher the flexibility of the electric wire conductor 1. For example, it is preferable that the repulsive force of the electric wire conductor 1 (a conductor of interest) according to a focused embodiment of the present disclosure is smaller than the repulsive force of a reference conductor obtained by forming the raw strand 9′ in which the sub-strands 8 are included at maximum density as illustrated in FIG. 2B, into a flat shape. The repulsive force of the conductor of interest is preferably 99% or lower of the repulsive force of the reference conductor, further preferably 95% or lower, 90% or lower, or 85% or lower. Here, the reference conductor may be formed of a raw strand made of the same material as the conductor of interest, having the same conductor cross-sectional area with maximum density structure, and formed into a flat shape with the same flattening ratio as the conductor of interest. In addition, the repulsive force may be measured in a state of an insulated electric wire in which an insulation coat of the same material and thickness is formed on the reference conductor and the conductor of interest, and the two may be compared. Since an insulation coat usually has higher flexibility than an electric wire conductor, a contribution of the insulation coat can be disregarded in comparing the repulsive force.

In the electric wire conductor 1 according to the present embodiment, the improvement in flexibility achieved by increasing the elemental-wire ratio is obtained by both effects of ensuring ease of relative movement of the elemental wires 3 and suppressing hardening of the elemental wires 3, as described above. Among these, the degree of hardening of the elemental wires 3 is reflected in a conductor resistance of the electric wire conductor 1. In copper and copper alloy, as well as aluminum or aluminum alloy, work hardening often results in an increase in conductor resistance. Therefore, the evaluation can be made such that the greater the conductor resistance, the greater the degree of hardening of the elemental wires 3 in the electric wire conductor 1 due to application of a load. An increase in conductor resistance compared to the raw strand 9 is preferably suppressed to 22% or lower, and more preferably 18% or lower. In addition, the conductor resistance of the electric wire conductor 1 is preferably smaller than the conductor resistance of the reference conductor.

### EXAMPLE

Examples will be described hereinafter. The present invention is not limited to those examples. Here, a relationship between an elemental-wire ratio and flexibility was studied for an insulated electric wire including an electric wire conductor having a flat shape. Hereinafter, preparation of samples and the evaluations were carried out at room temperature in the air.

### (Preparation of Sample)

First, an electric wire conductor composing samples A1 to A5 and samples B1 to B5 were prepared. A plurality of elemental wires of aluminum alloy are twisted together to form a sub-strand, and a plurality of the sub-strand of an identical type are twisted together to form a raw strand having a substantially circular cross-section. The raw strand was rolled into a flat shape by a roller to prepare the electric wire conductor having a flat shape. A layer structure in an arrangement of the sub-strands varies depending on the samples, as shown in Tables 1 and 2. In each sample, the layer structure of the electric wire conductor subjected to flattening is identical to the layer structure of the raw strand. In all samples, an outer diameter of the elemental wire was set according to a number of the elemental wire (number of the sub-strand) so that a conductor cross-sectional area was uniform at 62.0±0.6 mm² in a state of the raw strand. A flattening ratio of the electric wire conductor was controlled by an amount of a force applied from the roller to the raw strand, with the flattening ratio of 5 for samples A1 to A5 and a flattening ratio of 6 for samples B1 to B5.

An insulation coat was formed on an outer periphery of each of the electric wire conductor prepared above to prepare an insulated electric wire. The insulation coat was made of polyolefin, and a coating layer having a thickness of 0.6 mm was formed by extrusion molding.

### (Evaluation of Condition of Electric Wire Conductor)

For the electric wire conductor of each sample, confirmation was made as to whether a sub-strand structure was maintained, and whether the layer structure set by the arrangement of the sub-strands in the raw strand was maintained even after subjected to flattening. More specifically, in end portions of the flattened electric wire conductor, the twisted structures were untwisted on a sub-strand basis, and a distribution of the sub-strands was observed. This observation showed that the flattened electric wire conductor maintained the sub-strand structure and a predetermined layer structure set in the raw strand, constituting an outer layer and an inner layer.

Further, the insulated electric wire of each sample was embedded in acrylic resin and cut at a cross section perpendicular to an axial direction of the insulated electric wire to prepare a cross-sectional sample. By observing the cross-sectional sample, confirmation was made that the electric wire conductor was formed into a flat shape having a predetermined flattering ratio. In addition, the conductor cross-sectional area was calculated from the conductor weight.

### (Measurement of Repulsive Force)

The insulated electric wire of each sample was cut into a length of 400 mm, and both ends were held with grippers to bend the insulated electric wire. At this time, a bending radius (R) was set to 40 mm, and the load applied to the ends of the insulated electric wire was measured by a load cell attached to the grippers while bending to 135°. Load measurement was recorded as a repulsive force.

### (Measurement of Conductor Resistance)

A conductor resistance of each sample was measured by a resistance meter.

### (Evaluation Results)

First, for samples A2 and A5 as representative ones, a description will be made as to the structure and distribution of the sub-strands confirmed by untwisting the twisted structure in the ends of the electric wire conductors on a sub-strand basis. Based on the layer structure of the raw strand, the layer structure of sample A2 was set to “Jan. 6, 2012”, and the layer structure of sample A5 was set to “0-4-12”. FIGS. 3A to 3D show photographs of these samples taken in the untwisted state on a sub-strand basis. FIGS. 3A and 3B are photographs of sample A2, and FIGS. 3C and 3D are photographs of sample A5. FIGS. 3A and 3C show a state in which the twisted structure of the outer layer was untwisted, and FIGS. 3B and 3D show a state in which the outer layer was entirely removed and the twisted structure of the inner layer was untwisted.

These photographs show that in both samples A2 and A5, a plurality of groups of the elemental wires corresponding to the sub-strand are confirmed, and that the structure of the sub-strand, which is made up of a plurality of the elemental wires twisted together, is clearly maintained even after subjected to flattening. Further, the arrangement of the sub-strands maintains a state in which the outer layer (0) and the inner layer (I) are clearly distinguished. Especially, in the inner layer of sample A2 shown in FIG. 3B, the two-layer structure of the inner layer (I) can be confirmed, and a single sub-strand (II) composing an innermost layer can be distinguished from the other sub-strands placed around the outer periphery. From this distribution of the sub-strands, the predetermined layer structure set in the raw strand is confirmed to be maintained and an electric wire conductor having a flat shape is confirmed to be obtained. In other words, in the flattened electric wire conductor, the layer structure of “Jan. 6, 2012” is maintained in sample A2, and the layer structure of “0-4-12” is maintained in sample A5. Similarly, for the other samples, the sub-strand structure and the layer structure set in the raw strand were carried over to the flattened electric wire conductor.

Further, based on photographs of cross-sectional samples, an inner structure of the flattened electric wire conductor is examined. Here, results of examination will be described for the representative samples A2, A5, B2 and B5. Samples A2 and B2 have a layer structure of “Jan. 6, 2012,” and samples A5 and B5 have a layer structure of “0-4-12.” In addition, samples A2 and A5 have a flattening ratio of 5, and samples B2 and B5 have a flattening ratio of 6.

FIGS. 4A to 4D show cross-sectional photographs of the above-mentioned samples A2, A5, B2, and B5, respectively. In each cross-sectional photograph, it is confirmed that the electric wire conductor is formed into a flat shape having a predetermined flattening ratio. In either one of the electric wire conductors, it is confirmed that the elemental wires in an inner region are more deformed than in the outer periphery, especially in both widthwise regions. However, a degree of deformation of the elemental wires in the inner portion is found smaller in sample A5 than in sample A2, and in sample B5 than in sample B2, and it is confirmed that gaps are secured between the elemental wires in the inner portion. The elemental-wire ratio of the electric wire conductor is 1.71 (12/7) for samples A2 and B2, and 3 (12/4) for samples A5 and B5. In other words, the above tendency confirmed in the cross-sectional photographs indicates that the deformation and densification of the elemental wires in the inner layer are moderated by increasing the elemental-wire ratio of the electric wire conductor and decreasing the number of the elemental wires in the inner layer relative to the outer layer. Samples other than samples A2, A5, B2, and B5 were confirmed to have the same tendency. In addition, in the cross-sectional samples, the structure and distribution of the sub-strands in the electric wire conductor are difficult to see in relation to the operations of embedding in acrylic resin and cutting, and as shown in FIGS. 3A to 3D, the structure and distribution of the sub-strands which were confirmed while untwisting the twisted structure of the electric wire conductor cannot be clearly recognized in the cross-sectional photographs.

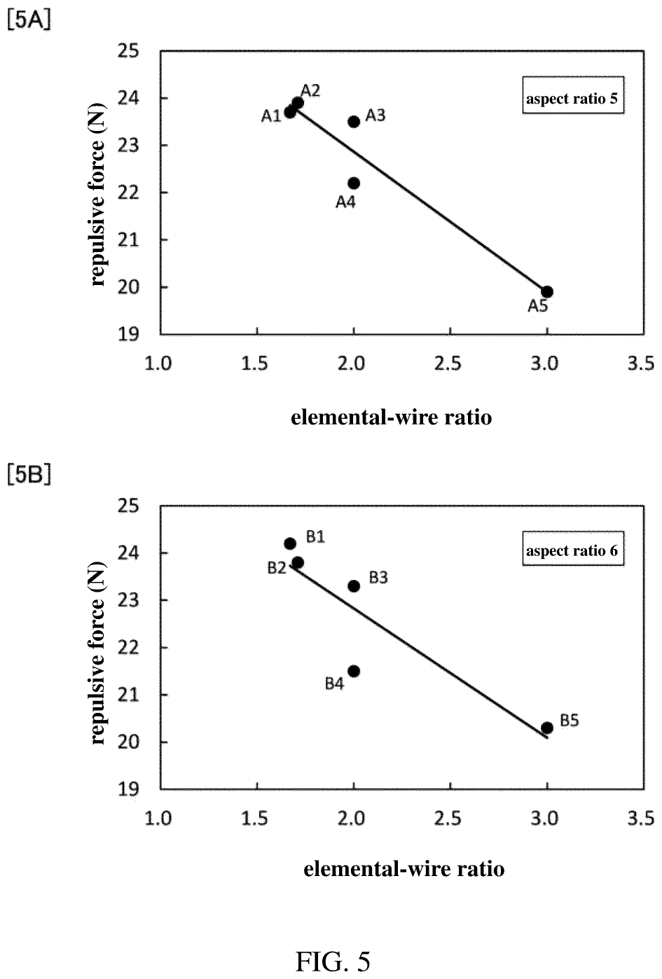

Next, Tables 1 and 2 show the layer configurations, the elemental-wire ratios, and evaluation results for samples A1 to A5 with the flattening ratio of 5 and samples B1 to B5 with an flattening ratio of 6, respectively. For the conductor cross-sectional area, it is also shown in parentheses, a ratio of change from the raw strand. Further, FIGS. 5A and 5B show a relationship between the elemental-wire ratio and the repulsive force for samples A1 to A5 and samples B1 to B5, respectively. The figure also shows an approximate line. Sample numbers are written near each plot point.

TABLE 1
Flattening Ratio 5

| Sample | | | | | |
|---|---|---|---|---|---|
| Number | A1 | A2 | A3 | A4 | A5 |
| Layer | 0-6-10 | 1-6-12 | 0-4-8 | 0-6-12 | 0-4-12 |
| Structure | | | | | |
| Elemental- | 1.67 | 1.71 | 2 | 2 | 3 |
| Wire | | | | | |
| Ratio | | | | | |
| Conductor | 62.5 | 61.5 | 61.7 | 62.6 | 62.9 |
| Cross- | (−0.1%) | (+0.2%) | (−0.1%) | (+0.1%) | (+0.7%) |
| Sectional | | | | | |
| Area | | | | | |
| (mm²) | | | | | |
| (Ratio of | | | | | |
| Change) | | | | | |
| Repulsive | 23.7 | 23.9 | 23.5 | 22.2 | 19.9 |
| Force (N) | | | | | |
| Conductor | 0.513 | 0.509 | 0.516 | 0.492 | 0.496 |
| Resistance | | | | | |
| (mΩ/m) | | | | | |

TABLE 2
Flattening Ratio 6

| Sample | | | | | |
|---|---|---|---|---|---|
| Number | B1 | B2 | B3 | B4 | B5 |
| Layer | 0-6-10 | 1-6-12 | 0-4-8 | 0-6-12 | 0-4-12 |
| Structure | | | | | |
| Elemental- | 1.67 | 1.71 | 2 | 2 | 3 |
| Wire | | | | | |
| Ratio | | | | | |
| Conductor | 60.0 | 59.5 | 59.5 | 60.6 | 60.9 |
| Cross- | (−4.1%) | (−3.0%) | (−3.7%) | (−3.0%) | (−2.6%) |
| Sectional | | | | | |
| Area | | | | | |
| (mm²) | | | | | |
| (Ratio of | | | | | |
| Change) | | | | | |
| Repulsive | 24.2 | 23.8 | 23.3 | 21.5 | 20.3 |
| Force (N) | | | | | |
| Conductor | 0.539 | 0.527 | 0.523 | 0.512 | 0.517 |
| Resistance | | | | | |
| (mΩ/m) | | | | | |

According to Tables 1 and 2 and FIGS. 5A and 5B, it can be seen that the larger the elemental-wire ratio, the lower the repulsive force and the higher the flexibility is, regardless of the flattening ratio employed. This can be interpreted as a result of the densification and deformation of the elemental wires in the inner layer being moderated by the increase in the elemental-wire ratio and the decrease in the number of elemental wires in the inner layer relative to the number of the elemental wires in the outer layer, as described above based on the cross-sectional photographs of FIGS. 4A to 4D. In other words, when the densification and deformation of the elemental wires in the inner layer are moderated, the elemental wires is facilitated to move relative to each other and component materials are less likely to harden, which is regarded to a result in high flexibility of the electric wire conductor. By setting the elemental-wire ratio to 2.0 or higher as in samples A3 to A5 and B3 to B5, the repulsive force can be reduced compared to the electric wire conductor having the layer structure “Jan. 6, 2012” (samples A2 and B2) formed from a raw strand in which conventional general sub-strands are included at maximum density. Especially, in samples A5 and B5, which have the elemental-wire ratio of 3, the repulsive force is significantly reduced.

Measurement results indicating the conductor resistance in Tables 1 and 2 show that the larger the elemental-wire ratio, the smaller the conductor resistance tends to be, in general. The magnitude of the conductor resistance is an index that reflects the load applied to the electric wire conductor during flattening processing and a degree of hardening of the elemental wires due to the load, and a small conductor resistance indicates a small degree of the load applied and hardening of the elemental wires. In other words, the hardening of the elemental wires is reduced in areas where the elemental-wire ratio is large, which contributes to an improvement of flexibility and the effect of facilitating relative movement of the elemental wires. The conductor resistance of the raw strand is 0.43 mΩ/m, and the conductor resistance of the flattened electric wire conductor in either one of samples increased from a state of the raw strand. The increase is kept small in samples with a large elemental-wire ratio.

Finally, comparing the evaluation results for the flattening ratio of 5 (samples A1 to A5) and the flattening ratio of 6 (samples B1 to B5), the load applied to the conductor during flattening processing is greater in the case of the flattening ratio of 6, which is reflected in a larger reduction in conductor cross-sectional area and higher conductor resistance. However, it is noticeable that the conductor resistance tends to be kept small when the elemental-wire ratio is increased in the case of the flatness ratio of 6. On the other hand, an effect of reducing the repulsive force by increasing the elemental-wire ratio is obtained to the same extent for all flatness ratios. Especially, similarly small repulsive forces were measured in samples A5 and B5 having an elemental-wire ratio of 3.

The embodiments of the present disclosure have been described in detail. The present invention is not limited to the embodiments as described above, but may be variously modified without departing from the scope of the present invention.

### LIST OF REFERENCE SIGNS

1: electric wire conductor
2: sub-strand
21: inner sub-strand
20: outer sub-strand
3: elemental wire
8: sub-strand
8i: raw inner sub-strand
80: raw outer sub-strand
9: raw strand
9′: raw strand (conventional)
h: height
W: width

1. An electric wire conductor, comprising:
a strand comprising a plurality of sub-strands, and
the plurality of the sub-strands comprising a plurality of elemental wires twisted together, wherein,
the strand comprises a flat portion having a flat outer shape in which a dimension in a width direction is larger than a dimension in a height direction, in a cross-section perpendicular to the axial direction of the strand;
the plurality of the sub-strands comprise outer sub-strands and at least one of inner sub-strands, the outer sub-strands placed at an outer periphery of the flat portion, and the inner sub-strands placed inside the outer sub-strands,
a ratio of a number of outer elemental wires to a number of inner elemental wires is 2.0 or higher, where a total number of the elemental wires composing the outer sub-strands is defined as the number of the outer elemental wires, and a total number of the elemental wires composing the inner sub-strands is defined as the number of the inner elemental wires-,
the electric wire conductor comprises an inner layer in which the inner sub-strands are provided in one layer or two layers, and an outer layer in which one layer of the outer sub-strands is placed around an outer periphery of the inner layer, and
a is 0 or 1; b is 4 or larger and 6 or smaller; and c is 8 or larger and 12 or smaller, where a indicates a number of the sub-strands composing an inner layer among the two layers of the inner layer; b indicates a number of the sub-strands composing an outer layer among the two layers of the inner layer; and c indicates a number of the sub-strands composing the outer layer, wherein when the inner layer is composed of only one layer, a is 0; and the number of the sub-strands composing the one inner layer is b.

2. The electric wire conductor according to claim 1, wherein the sub-strands comprise an identical number of the elemental wires to each other, and a ratio of the number of the outer sub-strands to the number of the inner sub-strands is 2.0 or higher.

3. The electric wire conductor according to claim 1, wherein the ratio of the number of the outer elemental wires to the number of the inner elemental wires is 3.0 or higher.

4. The electric wire conductor according to claim 1, wherein the inner sub-strands are provided in a single layer around an inner circumference of the outer sub-strands.

5. The electric wire conductor according to claim 1, wherein the cross-section of the electric wire conductor has a dimension in a width direction five times larger than a dimension in a height direction.

6. The electric wire conductor according to claim 1, wherein
the ratio of the
number of the outer elemental wires to the number of the inner elemental wires is 3.5 or lower.

7. The electric wire conductor according to claim 1, wherein the electric wire conductor comprises a conductor cross-sectional area of 16 mm² or larger.

8. The electric wire conductor according to claim 1, wherein at least a portion of the elemental wire is deformed from a circle and deformation ratio of the elemental wires from a circle is smaller at an outer periphery of the cross-section of the electric wire conductor than in an inner portion of the cross-section of the electric wire conductor.

9. An insulated electric wire, comprising
the electric wire conductor according to claim 1, and
an insulation cover covering the outer periphery of the electric wire conductor.

10. A wiring harness, comprising the insulated electric view according to claim 9.
